(19) United States
(12) Patent Application Publication
(10) Pub. No.: US 2014/0281976 A1
(43) Pub. Date: Sep. 18, 2014

(54) ADJUSTING CONTENT PLAYBACK TO CORRELATE WITH TRAVEL TIME

(71) Applicant: INTERNATIONAL BUSINESS MACHINES CORPORATION, Armonk, NY (US)

(72) Inventors: Gee N. Chia, Morrisville, NC (US); Christopher M. Laffoon, Durham, NC (US); Viswanath Srikanth, Chapel Hill, NC (US)

(73) Assignee: INTERNATIONAL BUSINESS MACHINES CORPORATION, Armonk, NY (US)

(21) Appl. No.: 13/833,621

(22) Filed: Mar. 15, 2013

(51) Int. Cl. G06F 3/01

(52) U.S. Cl. CPC G06F 3/01
USPC 715/716

(57) ABSTRACT

Embodiments of the present invention disclose a method, computer program product, and system for adjusting time duration of a content playlist corresponding to travel time. A computer receives a command to initiate a content playlist, wherein the content playlist includes a first of one or more content items. The computer receives travel information, wherein the travel information includes at least a destination and a method of travel. The computer determines an initial travel time. The computer determines an adjusted content playlist that corresponds to the initial travel time by utilizing the determined initial travel time. The computer sends a signal to present the adjusted content playlist. In another embodiment, a content item includes metadata comprising chapters corresponding to sections of the content item and playlists of chapters of the content item of various time durations.

### FIELD OF THE INVENTION

The present invention relates generally to the field of content playback, and more particularly to adjusting content responsive to travel time of an individual.

### BACKGROUND OF THE INVENTION

Mobile devices are becoming very popular for listening to audio broadcasts, such as news reports, while an individual is traveling. In response to this development, content providers can create offerings that take into account personal preferences of an individual (i.e. time duration of content). An audio broadcast can include metadata defining different sections of the audio broadcast (i.e. introduction, chapters, and conclusion), which can allow an individual to listen to a complete audio broadcast, or a subset of the audio broadcast responsive to the amount of time the individual is able to listen. Mobile devices can remain connected to wireless network communications (i.e. internet, 3G and 4G mobile telecommunications) throughout an individuals travels. This allows the individual to have consistent access to content while traveling.

A large number of mobile devices include a Global Positioning System (GPS) receiver that can monitor and broadcast the geographical location of the mobile device. GPS receivers receive GPS signals from satellites to determine the geographical location of the GPS receiver, and concurrently, the location of the associated mobile device. In examples, a mobile device can utilize a GPS receiver to provide directions to a destination, travel distance to a destination, and an estimated time of arrival to a destination. In some embodiments, mobile devices can use a GPS receiver in conjunction with a traffic prediction service in order to take into account traffic congestion while calculating an estimated time of arrival to a destination.

### SUMMARY

Embodiments of the present invention disclose a method, computer program product, and system for adjusting time duration of a content playlist corresponding to travel time. A computer receives a command to initiate a content playlist, wherein the content playlist includes a first of one or more content items. The computer receives travel information, wherein the travel information includes at least a destination and a method of travel. The computer determines an initial travel time. The computer determines an adjusted content playlist that corresponds to the initial travel time by utilizing the determined initial travel time. The computer sends a signal to present the adjusted content playlist. In another embodiment, a content item includes metadata comprising chapters corresponding to sections of the content item and playlists of chapters of the content item of various time durations.

### BRIEF DESCRIPTION OF THE SEVERAL VIEWS OF THE DRAWINGS

FIG. 1 is a functional block diagram of a data processing environment in accordance with an embodiment of the present invention.

FIG. 2 is a flowchart depicting operational steps of a program for modifying content responsive to a change in travel time for a client device, in accordance with an embodiment of the present invention.

FIG. 3 depicts a block diagram of components of the computing systems of FIG. 1 in accordance with an embodiment of the present invention.

### DETAILED DESCRIPTION

Embodiments of the present invention recognize that with an increasing use of mobile phones, and more particularly smartphones, individuals that are traveling can maintain a connection to the internet while traveling. Travelers often want to hear audio broadcasts that are of a time duration that corresponds closely with the travelers travel time. Content providers can create offerings of content that take into account traveler's preferences with regards to the time duration of content and content types.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk, C++ or the like and conventional procedural programming languages, such as the “C” programming language or similar programming languages. The program code may execute entirely on a individual's computer, partly on the individual's computer, as a stand-alone software package, partly on the individual's computer and partly on a remote computer or entirely on the remote computer or server. In the latter scenario, the remote computer may be connected to the individual's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

The present invention will now be described in detail with reference to the Figures. FIG. 1 is a functional block diagram illustrating data processing environment 100, in accordance with one embodiment of the present invention.

An exemplary embodiment of data processing environment 100 includes provider 102, network 104, client device 106, dynamic content service 108, and traffic prediction service 110. In one embodiment, provider 102, dynamic content service 108, and traffic prediction service 110 can be desktop computers, specialized computer servers, or any other computer systems known in the art. In certain embodiments, provider 102, dynamic content service 108, and traffic prediction service 110 represent computer systems utilizing clustered computers and components (e.g., database server computers, application server computers, etc.) that act as a single pool of seamless resources when accessed by elements of data processing environment 100. In general, provider 102, dynamic content service 108, and traffic prediction service 110 are representative of any electronic device or combination of electronic devices capable of executing machine-readable program instructions, as described in greater detail with regard to FIG. 3.

In one embodiment, provider 102 includes content database 112 and content editor 116. In this embodiment, content database 112 includes content item 114. In the depicted example of data processing environment 100, provider 102 administers content item 114 stored in content database 112 to dynamic content service 108 and client device 106 through network 104. Further, provider 102 can administer other data, such as metadata or other information associated with content item 114. Data processing environment 100 is an exemplary depiction of an environment including one provider 102. In other exemplary embodiments, data processing environment 100 can include more than one provider 102, wherein each additional provider includes substantially similar elements to provider 102. Content database 112 can be implemented with any type of storage device that is capable of storing data that may be accessed and utilized by provider 102, client device 106, and dynamic content service 108, such as a database server, a hard disk drive, or flash memory. In other embodiments, content database 112 can represent multiple storage devices within provider 102. In an exemplary embodiment, content database 112 includes all instances of content (i.e. content item 114) associated with provider 102. In various embodiments of the present invention, content item 114 can represent audio tracks (i.e. news stories, podcasts, radio programs), or video content that provider 102 creates, stores, or distributes. In one embodiment, when content item 114 is sent and/or received by elements of data processing environment 100, associated metadata defined in content editor 116 is included within content item 114.

In one embodiment, provider 102 includes content editor 116 for marking up content item 114 with metadata. In an exemplary embodiment where content item 114 is representative of an audio broadcast of a news story, provider 102 utilizes content editor 116 to create metadata corresponding to content item 114. In this example, the metadata can indicate chapters corresponding to sections of content item 114. For an exemplary content item 114 that has a time duration of 10 minutes, the associated metadata can define an introductory chapter (3 minutes), a few body chapters of varying time durations (total of 5 minutes), and a conclusion chapter (2 minutes). In another embodiment, provider 102 utilizes content editor 116 to define chapter playlists of content item 114 of various time durations, wherein the chapter playlist is a sequence of chapters, and the order in which the chapters should be played.

In this embodiment, the chapter playlists would include a minimum playlist defining the chapters of content item 114 that are required in order for an understanding of content item 114, as well as other playlists of various time durations. In the example of content item 114 having a time duration of 10 minutes, content editor 116 defines a minimum playlist including the introduction chapter (3 minutes), one body chapter (1 minute), and the conclusion chapter (2 minutes), and also other playlists of various time durations. In an example, provider 102 can utilize content editor 116 to assign metadata tags in the form of various tag formats including ID3v2. Content item 114, along with associated metadata is stored in content database 112 for access by elements of data processing environment 100.

Network 104 can be, for example, a local area network (LAN), a telecommunications network, a wide area network (WAN) such as the Internet, or a combination of the three, and include wired, wireless, or fiber optic connections. In general, network 104 can be any combination of connections and protocols that will support communications between provider 102, client device 106, dynamic content service 108, and traffic prediction service 110 in accordance with a desired embodiment of the present invention. Content item 114 can be sent to and from various elements of data processing environment 100 through network 104.

In one embodiment, client device 106 includes user interface 120, system software 122, Global Positioning System (GPS) 124, and application 126. In various embodiments of the present invention, client device 106 may be a workstation, personal computer, personal digital assistant, mobile phone, or any other device capable of executing program instructions. In general, client device 106 is representative of any electronic device or combination of electronic devices capable of executing machine-readable program instructions, as described in greater detail with regard to FIG. 3. In an exemplary embodiment, client device 106 can be representative of a mobile device, and more particularly a smartphone. User interface 120 allows for input into the elements of client device 106. In one embodiment, system software 122 may exist in the form of operating system software, which may be Windows®, LINUX®, and other application software such as internet applications and web browsers. In one embodiment, GPS 124 is representative of a GPS receiver that client device 106 can utilize to share and determine the geographic location of client device 106. In an example, GPS 124 can be utilized to determine the geographic location of client device 106, and utilize the geographic location of client device 106 to determine a travel time to another geographic location, including an estimated time of arrival. In one embodiment, application 126 is representative of application software on client device 106 that can be utilized to send and receive data from provider 102 and/or dynamic content service 108. In an exemplary embodiment, an individual utilizing client device 106 can utilize user interface 120 to create a playlist of at least one content item 114 by identifying at least one content item 114 located on provider 102 to listen to through application 126. In this embodiment, the playlist is a selection of at least one content item 114, the definition of playlists is discussed in greater detail with regard to FIG. 2.

In one embodiment, dynamic content service 108 includes content playlist 118 and dynamic content feed program 200. In an example, when client device 106 identifies content item 114 on provider 106 to add to a playlist, dynamic content service 108 retrieves content item 114 (along with associated metadata) from provider 102 and stores content item 114 in content playlist 118 associated with client device 106. In other embodiments, dynamic content service 108 includes multiple instances of content playlist 118, wherein each instance of content playlist 118 is associated with a client device 106. Content playlist 118 can be implemented with any type of storage device that is capable of storing data capable which may be accessed and utilized by elements of provider 102, client device 106, and dynamic content service 108, such as a database server, a hard disk drive, or flash memory. In other embodiments, content playlist 118 can represent multiple storage devices within dynamic content service 108. In an alternate embodiment where client device 106 identifies more than one content item 114 to add to a playlist, dynamic content service 108 retrieves all identified content items 114 (along with all associated metadata) from provider 102 and stored content items 114 in content playlist 118. The definition and retrieval of content item 114 by dynamic content service 108 is discussed in greater detail with regard to FIG. 2. In one embodiment, dynamic content feed program 200 communicates with provider 102, client device 106, and traffic prediction service 110 to control the feed of content item 114 in accordance with exemplary embodiments of the present invention. Dynamic content feed program 200 is discussed in greater detail with regard to FIG. 2.

In one embodiment, traffic prediction service 110 includes traffic congestion information that dynamic content feed program 200 can utilize. In exemplary embodiments traffic congestion information can include any type of information related to traffic flow. In exemplary embodiments, the information related to traffic flow includes accident reports, traffic congestion patterns, and real-time traffic information. In one embodiment, dynamic content feed program 200 utilizes traffic prediction service 110 to determine a change in an estimated arrival time of client device 106 in accordance with exemplary embodiments of the present invention that are discussed in greater detail with regard to FIG. 2.

FIG. 2 is a flowchart depicting operational steps of dynamic content program 200 in accordance with an exemplary embodiment of the present invention. In one embodiment, dynamic content feed program 200 accesses content item 114 in provider 102 after content item 114 has been marked up with associated metadata by content editor 116. Dynamic content feed program 200 can communicate with client device 106 through network 104 utilizing application 126.

In step 202, dynamic content feed program 200 receives input of desired content item 114. In one embodiment, dynamic content feed program 200 receives input in user interface 120. In exemplary embodiments, an individual utilizing client device 106 utilizes application 126 to select content item 114 on provider 102. In an example, prior to beginning travel an individual utilizing client device 106 utilizes application 126 to determine a playlist consisting of content item 114 to listen to during travel. In another example, prior to beginning travel an individual utilizing client device 106 utilizes application 126 to determine a playlist consisting of more than one content item 114 to listen to during travel. In this example, the individual utilizing client device 106 utilizes application 126 to determine an indication of priority for each content item 114 (i.e. ranking each content item 114 in order of importance, indicating that each content item 114 is of equal importance).

In step 204, dynamic content feed program 200 retrieves content item 114 from provider 102. In one embodiment, dynamic content feed program 200 retrieves content item 114 (defined in step 202) along with associated metadata and stores content item 114 along with associated metadata in content playlist 118. In an example, dynamic content feed program 200 utilizes information received from client device 106 in step 202 to create a playlist (content playlist 118), for client device 106 to play during travel.

In step 206, dynamic content feed program 200 receives a command to initiate content playlist 118. In one embodiment, an individual utilizing client device 106 utilizes application 126 to send a command to initiate content playlist 118 to dynamic content feed program 200. In another embodiment, when client device 106 initiates content playlist 118, the individual utilizing client device 106 utilizes application 126 to specify travel information. In this embodiment, the travel information includes, at least in part, a destination (i.e. a physical address), and a method of travel (i.e. car, walking, public transportation). In an example, an individual utilizing client device 106 is driving to a store. In this example, the individual inputs an address of the store and the method of travel to be a car into application 126. In one embodiment, upon sending a command to initiate content playlist 118, client device 106 starts sharing geographic location information of client device 106 through GPS 124. In another embodiment, client device 106 starts to share geographic location information of client device 106 through GPS 124 with dynamic content feed program 200 upon initiation of dynamic content feed program 200.

In step 208, dynamic content feed program 200 determines travel time. In one embodiment, dynamic content feed program 200 utilizes travel information (provided in step 206), GPS 124, and traffic prediction service 110 to determine a travel time for client device 106. In the example of an individual utilizing client device 106 while driving to a store, dynamic content feed program 200 accesses GPS 124 and traffic prediction service 110, and utilizes travel information input into application 126 to determine an estimated arrival time of client device 106 to the store. In this example, dynamic content feed program 200 utilizes the estimated arrival time to determine the travel time if client device 106.

In step 210, dynamic content feed program 200 determines the playlist of content item 114 to play. In one embodiment, responsive to the travel time determined in step 208, dynamic content feed program 200 utilizes metadata associated with content item 114 to determine a playlist of chapters of content item 114 that corresponds to the determined travel time. In an example, content item 114 stored in content playlist 118 has a time duration of 10 minutes, with associated metadata defining an introductory chapter (3 minutes), a few body chapters of varying time durations (total of 5 minutes), and a conclusion chapter (2 minutes). In this example, dynamic content feed program 200 also determines a travel time of 7 minutes (in step 208). Utilizing metadata associated with content item 114, dynamic content feed program 200 determines a playlist of chapters of content item 114 that is close to the travel time of client device 106 (7 minutes). In this example, dynamic content feed program 200 determines a playlist totaling 7 minutes, comprising the introductory chapter (3 minutes), two body chapters (totaling 2 minutes), and the conclusion chapter (2 minutes).

In another example with regard to content item 114 with a 10 minute time duration, in step 208 dynamic content feed program 200 determines that the travel time was 5 minutes. In this example, metadata associated with content item 114 indicates a minimum playlist for content item 114 with a time duration of 6 minutes, wherein the minimum playlist comprises an introductory chapter (3 minutes), one body chapter (1 minute), and a conclusion chapter (2 minutes). In such an example, since the travel time is less than the time duration of the minimum playlist of content item 114 dynamic content feed program 200 determines the minimum playlist is the appropriate playlist of content item 114 for client device 106. In yet another example with regard to content item 114 with a 10 minute time duration, in step 208, dynamic content feed program 200 determines that the travel time is 11 minutes. In this example, since the travel time is greater than the time duration of content item 114, dynamic content feed program 200 determines that all chapters of content item 114 can be played.

In another example, client device 106 determines a playlist comprising two content items 114 and indicates that each content item 114 is a different priority (in step 202). In this example, each content item 114 has a time duration of 10 minutes with metadata defining chapters and a minimum playlist as previously discussed with regard examples of content item 114 with a 10 minute time duration. In this example, dynamic content feed program 200 determines (in step 208) that the travel time is 18 minutes. In such an example, responsive to the 18 minute travel time, dynamic content feed program 200 can determine a playlist comprising all chapters of content item 114 of highest priority (10 minutes), and an abbreviated playlist of content item 114 of lowest priority (8 minutes), wherein the abbreviated playlist of content item 114 of lowest priority is defined in associated metadata. In various embodiments, an individual utilizing client device 106 can determine a priority to define the order that dynamic content feed program 200 plays content playlist 118 to client device 106, or dynamic content feed program 200 can utilize other methods to determine the order of content playlist 118. In an alternate embodiment of this example, client device 106 indicates that each content item 114 is of equal priority. In such an example, responsive to an 18 minute travel time, dynamic content feed program 200 can determine a playlist comprising an abbreviated playlist of each content item 114 (8 minutes each).

In step 212, dynamic content feed program 200 initiates content playlist 118. In one embodiment, dynamic content feed program 200 initiates content playlist 118 that comprises a playlist of content item 114 (determined in step 210) by beginning to send content playlist 118 to application 126 on client device 106.

In step 214, dynamic content feed program 200 queries traffic prediction service 110 and GPS 124 of client device 106. In one embodiment, dynamic content feed program 200 utilizes travel information (provided in step 206), GPS 124, and traffic prediction service 110 to determine an updated estimated time of arrival for client device 106. The determination of an estimated arrival time for client device 106 is discussed in greater detail with regard to step 208.

In decision step 216, dynamic content feed program 200 determines whether the estimated arrival time has changed. In one embodiment, dynamic content feed program 200 compares the updated estimated time of arrival determines in step 214 to the initial time of arrival determined in step 208 to determine whether there has been a change in estimated arrival time. If dynamic content feed program 200 determines that the estimated arrival time has not changed, then dynamic content feed program 200 repeats step 214. In one embodiment, repeating step 214 responsive to dynamic content feed program 200 determining that the estimated arrival time has not changed allows dynamic content feed program 200 to repeatedly check the estimated arrival time of client device 106.

In step 218, dynamic content feed program 200 adjusts content playlist 118. In one embodiment, responsive to dynamic content feed program 200 determining that the estimated arrival time has changed (in decision step 216), dynamic content feed program 200 readjusts content playlist 118 corresponding to the change in estimated arrival time. In the previously discussed example of a travel time of 7 minutes and content playlist 118 comprising content item 114 with a time duration of 10 minutes, dynamic content feed program 200 can determine that the estimated arrival time has increased by 1 minute, which changes the travel time to a total of 8 minutes. In this example, dynamic content feed program 200 adjusts content playlist 118 through an addition of one or more body chapters of content item 114, increasing the time duration of the abbreviated playlist of content item 114 to a total of 8 minutes (equal to travel time). In another embodiment of the example of a travel time of 7 minutes and content playlist 118 comprising content item 114 with a time duration of 10 minutes, dynamic content feed program 200 can determine that the estimated arrival time has decreased by 1 minute, which changes the travel time to a total of 6 minutes. In such an example, dynamic content feed program 200 adjusts content playlist 118 through a subtraction of one or more body chapters of content item 114, decreasing the time duration of the abbreviated playlist of content item 114 to a total of 6 minutes (equal to travel time). In exemplary embodiments where dynamic content feed program 200 determines that the estimated arrival time decreases, dynamic content feed program 200 does not remove chapters defined as part of the minimal playlist of content item 114 in the associated metadata. In one embodiment, dynamic content feed program 200 periodically repeats step 214 through step 218 until client device 106 reaches the defined destination, allowing an individual utilizing client device 106 to complete content playlist 118 upon arriving at the defined destination. Dynamic content feed program 200 ends when client device 106 arrives at the defined destination. In an alternate embodiment, dynamic content feed program 200 can adjust content playlist 118 through input by the individual utilizing client device 106 (i.e. requesting to hear more of content item 114, indicating to skip to next content item 114). In another alternate embodiment, dynamic content feed program 200 can alert client device 106 that the estimated time of arrival has changed, and the reason for the change (i.e. traffic on route).

FIG. 3 depicts a block diagram of components of computer 300, which is representative of provider 102 client device 106, dynamic content service 108 and traffic prediction service 110 in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

Computer 300 includes communications fabric 302, which provides communications between computer processor(s) 304, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer-readable storage media. In this embodiment, memory 306 includes random access memory (RAM) 314 and cache memory 316. In general, memory 306 can include any suitable volatile or non-volatile computer-readable storage media. Software and Data 322 stored in persistent storage 308 for execution and/or access by processor(s) 304 via one or more memories of memory 306. With respect to provider 102, software and data 322 includes content editor 116. With respect to client device 106, software and data 322 include system software 122, GPS 124, and application 126. With respect to dynamic content service 108, software and data 322 includes dynamic content feed program 200.

In this embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer-readable storage medium that is also part of persistent storage 308.

Communications unit 310, in these examples, provides for communications with other data processing systems or devices. In these examples, communications unit 310 includes one or more network interface cards. Communications unit 310 may provide communications through the use of either or both physical and wireless communications links. Software and data 322 may be downloaded to persistent storage 308 through communications unit 310.

I/O interface(s) 312 allows for input and output of data with other devices that may be connected to computer 300. For example, I/O interface 312 may provide a connection to external devices 318 such as a keyboard, keypad, a touch screen, and/or some other suitable input device. External devices 318 can also include portable computer-readable storage media such as, for example, thumb drives, portable optical or magnetic disks, and memory cards. Software and data 322 can be stored on such portable computer-readable storage media and can be loaded onto persistent storage 308 via I/O interface(s) 312. I/O interface(s) 312 also connect to a display 320.

Display 320 provides a mechanism to display data to a user and may be, for example, a computer monitor. Display 320 can also function as a touch screen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for adjusting time duration of a content playlist corresponding to travel time, the method comprising:
a computer receiving a command to initiate a content playlist, wherein the content playlist includes a first of one or more content items;
the computer receiving travel information, wherein the travel information includes at least a destination and a method of travel;
the computer determining an initial travel time;
the computer determining an adjusted content playlist corresponding to the determined initial travel time by utilizing the determined initial travel time; and
the computer sending a signal to present the adjusted content playlist.

2. The method of claim 1, wherein a content item is audio media or video media.

3. The method of claim 1, wherein the computer determines the initial travel time utilizing the travel information and a Global Positioning System (GPS).

4. The method of claim 1, wherein a content item includes metadata comprising chapters corresponding to sections of the content item and playlists of chapters of the content item of various time durations.

5. The method of claim 4, further comprising:
the computer determining an updated travel time utilizing a traffic prediction service that provides information related to real-time traffic information; and
responsive to determining the updated travel time is different than the initial travel time, the computer readjusting the adjusted content playlist corresponding to the updated travel time.

6. The method of claim 4, wherein said determining an adjusted content playlist corresponding to the determined initial travel time, comprises:
the computer accessing metadata associated with the first of the one or more content items; and
the computer determining an adjusted content playlist comprising chapters of the first of one or more content items, wherein the time duration of the adjusted content playlist corresponds to the initial travel time.

7. The method of claim 5, wherein said readjusting the adjusted content playlist corresponding to the updated travel time, comprises:
the computer accessing metadata associated with the first of the one or more content items; and
the computer determining a readjusted content playlist comprising chapters of the first of one or more content items, wherein the time duration of the readjusted content playlist corresponds to the updated travel time.

8. The method of claim 1, wherein the content playlist comprises a second of one or more content items and an indication of priority of the one or more content items.

9. A computer program product for adjusting time duration of a content playlist corresponding to travel time, the computer program product comprising:
one or more computer-readable storage media and program instructions stored on the one or more computer-readable storage media, the program instructions comprising:
program instructions to receive receiving a command to initiate a content playlist, wherein the content playlist includes a first of one or more content items;
program instructions to receive travel information, wherein the travel information includes at least a destination and a method of travel;
program instructions to determine an initial travel time;
program instructions to determine an adjusted content playlist corresponding to the determined initial travel time by utilizing the determined initial travel time; and
program instructions the computer sending a signal to present the adjusted content playlist.

10. The computer program product of claim 9, wherein a content item is audio media or video media.

11. The computer program product of claim 9, wherein program instructions to determine the initial travel time utilizes the travel information and a Global Positioning System (GPS).

12. The computer program product of claim 9, wherein a content item includes metadata comprising chapters corresponding to sections of the content item and playlists of chapters of the content item of various time durations.

13. The computer program product of claim 12, further comprising program instruction to:
determine an updated travel time utilizing a traffic prediction service that provides information related to real-time traffic information; and
responsive to determining the updated travel time is different than the initial travel time, to readjust the adjusted content playlist corresponding to the updated travel time.

14. The computer program product of claim 12, wherein said program instructions to determine an adjusted content playlist corresponding to the determined initial travel time, comprise program instructions to:
access metadata associated with the first of the one or more content items; and
determine an adjusted content playlist comprising chapters of the first of one or more content items, wherein the time duration of the adjusted content playlist corresponds to the initial travel time.

15. The computer program product of claim 13, wherein said program instructions to readjust the adjusted content playlist corresponding to the updated travel time, comprise program instructions to:
access metadata associated with the first of the one or more content items; and
determine a readjusted content playlist comprising chapters of the first of one or more content items, wherein the time duration of the readjusted content playlist corresponds to the updated travel time.

16. The computer program product of claim 9, wherein the content playlist comprises a second of one or more content items and an indication of priority of the one or more content items.

17. A computer system for adjusting time duration of a content playlist corresponding to travel time, the computer system comprising:
one or more computer processors;
one or more computer-readable storage media;
program instructions stored on the computer-readable storage media for execution by at least one of the one or more processors, the program instructions comprising:
program instructions to receive receiving a command to initiate a content playlist, wherein the content playlist includes a first of one or more content items;
program instructions to receive travel information, wherein the travel information includes at least a destination and a method of travel;
program instructions to determine an initial travel time;
program instructions to determine an adjusted content playlist corresponding to the determined initial travel time by utilizing the determined initial travel time; and
program instructions the computer sending a signal to present the adjusted content playlist.

18. The computer system of claim 17, wherein a content item includes metadata comprising chapters corresponding to sections of the content item and playlists of chapters of the content item of various time durations.

19. The computer system of claim 18, further comprising program instruction to:
determine an updated travel time utilizing a traffic prediction service that provides information related to real-time traffic information; and
responsive to determining the updated travel time is different than the initial travel time, to readjust the adjusted content playlist corresponding to the updated travel time.

20. The computer system of claim 18, wherein said program instructions to determine an adjusted content playlist corresponding to the determined initial travel time, comprise program instructions to:
access metadata associated with the first of the one or more content items; and
determine an adjusted content playlist comprising chapters of the first of one or more content items, wherein the time duration of the adjusted content playlist corresponds to the initial travel time.
